(19) United States
(12) Patent Application Publication
(10) Pub. No.: US 2023/0274216 A1
(43) Pub. Date: Aug. 31, 2023

(54) DELIVERY PLAN GENERATION APPARATUS, DELIVERY PLAN GENERATION METHOD, AND PROGRAM

(71) Applicant: NIPPON TELEGRAPH AND TELEPHONE CORPORATION, Tokyo (JP)

(72) Inventors: Kazuaki AKASHI, Musashino-shi, Tokyo (JP); Shunsuke KANAI, Musashino-shi, Tokyo (JP); Satoshi SUZUKI, Musashino-shi, Tokyo (JP); Chao WU, Musashino-shi, Tokyo (JP); Shohei NISHIKAWA, Musashino-shi, Tokyo (JP); Naomi MURATA, Musashino-shi, Tokyo (JP); Manami OGAWA, Musashino-shi, Tokyo (JP)

(73) Assignee: NIPPON TELEGRAPH AND TELEPHONE CORPORATION, Tokyo (JP)

(21) Appl. No.: 18/020,287

(22) PCT Filed: Aug. 21, 2020
(86) PCT No.: PCT/JP2020/031648

§ 371 Date: Feb. 8, 2023

(51) Int. Cl. G06Q 10/083; G06Q 10/04

(52) U.S. Cl. CPC G06Q 10/083; G06Q 10/04

(57) ABSTRACT

A delivery plan creation device according to an aspect of the invention creates a delivery plan including an order of delivery of fuel to each of destinations using a delivery vehicle and an amount of fuel to be supplied. The delivery plan creation device includes a database, a storage unit, and a processor. The database holds environment information including destination information related to the destination and delivery vehicle information related to the delivery vehicle. The storage unit stores a trained model created by training a neural network having at least an input layer and an output layer in advance based on different environment information. The processor includes an acquisition unit and a creation unit. The acquisition unit accesses the database to acquire the environment information and create an input condition that is a premise of the delivery plan from the environment information. The creation unit inputs the input condition to the neural network in which the trained model has been reflected to create the delivery plan.

### TECHNICAL FIELD

An aspect of this invention relates to a delivery plan creation device, a delivery plan creation method, and a program.

### BACKGROUND ART

Delivery services provided for logistics have drawn attention in recent years. The delivery services include not only delivering luggage such as parcels but also delivering in preparation for disasters such as earthquakes and typhoons. Fuel is indispensable not only for generating warmth but also securing electric power. For example, when power supply from a power plant is interrupted due to a disaster or the like, a communication service provider operates a private generator installed in a building for provision of a communication service (a communication building) to continue providing the communication service. The service provider (the communication provider, the delivery service provider, etc.) delivers and supplies fuel to operate the private generator to the communication building using a delivery vehicle, etc.

A fuel depletion period indicates a period during which fuel of a private generator is depleted. That is, in this period, private power generation cannot be performed, and therefore the communication service may not be continued. The service provider should create a delivery plan to make the fuel depletion period zero or shorten the fuel depletion period to as short as possible. In other words, the service provider is required not only to have fuel delivered to the communication building before fuel is depleted but also to quickly deliver fuel to the communication building suffering depletion of fuel and restore the communication service at an early stage.

A delivery plan indicates how much fuel should be delivered to a plurality of destinations in which order. A delivery plan should be determined according to various situations such as the location, fuel situation, and traffic situation with respect to each building. For this reason, a long time and skills are required for a person to review and create a delivery plan. Despite the fact that it is intricate to train personnel skilled in dealing with disasters because disasters rarely occur, once a disaster occurs, the situation becomes urgent. A technique capable of causing a delivery plan to be automatically and efficiently created in a short period of time has been demanded.

PTL 1 discloses a system for creating a delivery plan for consumer goods such as LP gas cylinders. This document proposes a technique for automatically creating an efficient delivery plan taking the amount of remaining consumer goods at a destination into consideration.

### CITATION LIST

### Patent Literature

[PTL 1] Japanese Patent Application Laid-open No. 2019-219783

### SUMMARY OF INVENTION

### Technical Problem

In addition, the following methods are available.

For example, there is a method of performing delivery in an order in which the total travel distance of a delivery vehicle becomes shorter. However, in this method, a destination located closer to the delivery vehicle is given priority. There is a possibility of delivery to a distant destination with a small amount of remaining fuel being delayed and thus fuel being depleted.

Alternatively, there is a method of performing delivery in an order from destinations with smaller amounts of remaining fuel. However, in this method, the locations of the destinations and the times required for the delivery are not considered. Therefore, in a case where destinations with smaller amounts of remaining fuel are scattered, an inefficient delivery plan is likely to be created.

Consequently, there is a possibility of the fuel being depleted at many destinations.

Alternatively, there is a method of creating all delivery plans and extracting the best plan from among them. However, in this method, when there are many destinations and delivery vehicles, an enormous number of delivery plans can be created. A long period of time may be required for the calculation.

It is hard to say that an effective delivery plan can be efficiently created in any of these methods.

The present invention has been made by paying attention to the above circumstances, and it is an object of the present invention to provide a technique enabling a delivery plan that can shorten a fuel depletion period to be efficiently created.

### Solution to Problem

A delivery plan creation device according to an aspect of this invention creates a delivery plan including an order of delivery of fuel to each of destinations using a delivery vehicle and an amount of fuel to be supplied. The delivery plan creation device includes a database, a storage unit, and a processor. The database holds environment information including destination information related to the destination and delivery vehicle information related to the delivery vehicle. The storage unit stores a trained model created by training a neural network having at least an input layer and an output layer in advance based on different environment information. The processor includes an acquisition unit and a creation unit. The acquisition unit accesses the database to acquire the environment information and create an input condition that is a premise of the delivery plan from the environment information. The creation unit inputs the input condition to the neural network in which the trained model has been reflected to create the delivery plan.

### Advantageous Effects of Invention

According to one aspect of the present invention, it is possible to provide a technique capable of causing a delivery plan that can shorten a fuel depletion period to be efficiently created.

### BRIEF DESCRIPTION OF DRAWINGS

FIG. 1 is a diagram showing an example of a system including a delivery plan creation device according to a first embodiment of the invention.

FIG. 2 is a diagram for explaining environment information held in an environment information database 12a.

FIG. 3 is a diagram showing an example of destination information.

FIG. 4 is a diagram showing an example of delivery vehicle information.

FIG. 5 is a diagram showing an example of a neural network according to an embodiment.

FIG. 6 is a flowchart showing an example of a processing procedure for learning of the neural network.

FIG. 7 is a flowchart showing an example of a processing procedure of step S3 of FIG. 6.

FIG. 8 is a diagram showing an example of information created in step S31 of FIG. 7.

FIG. 9 is a diagram showing an example of information created in step S32 of FIG. 7.

FIG. 10 is a flowchart showing an example of a processing procedure for creation of a delivery plan.

FIG. 11 is a flowchart showing an example of a processing procedure for an updating unit 112.

FIG. 12 is a diagram showing an example of a reward function.

FIG. 13 is a diagram showing another example of the reward function.

FIG. 14 is a diagram showing another example of the reward function.

FIG. 15 is a flowchart showing an example of a processing procedure for creation of a delivery plan.

FIG. 16 is a diagram showing an example of a delivery plan.

FIG. 17 is a diagram showing an example of an action based on the delivery plan of FIG. 16.

### DESCRIPTION OF EMBODIMENTS

Hereinafter, embodiments according to the present invention will be described with reference to the drawings.

### Configuration

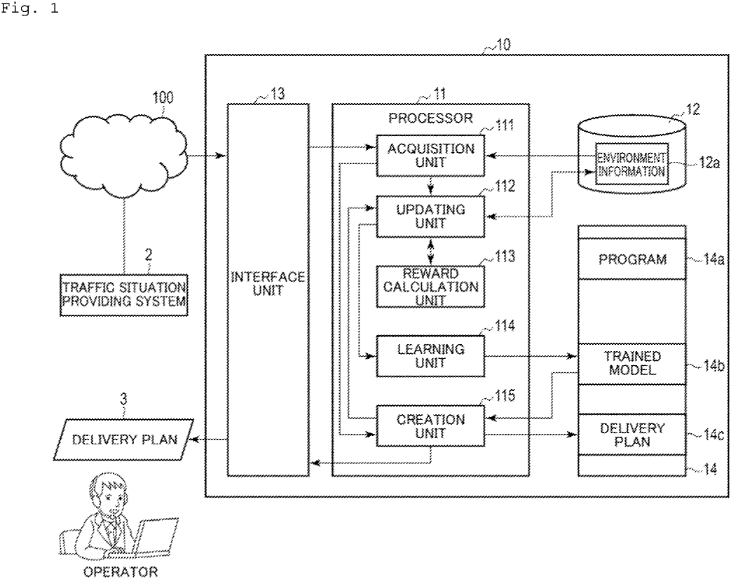

FIG. 1 is a diagram showing an example of a system including a delivery plan creation device according to a first embodiment of the invention. In FIG. 1, the delivery plan creation device 10 includes a processor 11, a storage 12, an interface unit 13, and a memory 14. That is, the delivery plan creation device 10 is a computer, and is implemented as, for example, a personal computer, a server computer, or the like.

The interface unit 13 is connected to a network 100, and can access, for example, a traffic situation providing system 2 to acquire information such as a current traffic situation. In addition, the interface unit 13 outputs a delivery plan 3 created by the delivery plan creation device 10, for example, in response to a request from an operator of a vehicle dispatch center.

The storage 12 is a non-volatile storage device (block device), for example, a hard disk drive (HDD) or a solid state drive (SSD). The storage 12 stores an environment information database 12a in addition to basic programs such as an operating system (OS) and a device driver and programs for realizing functions of the delivery plan creation device 10.

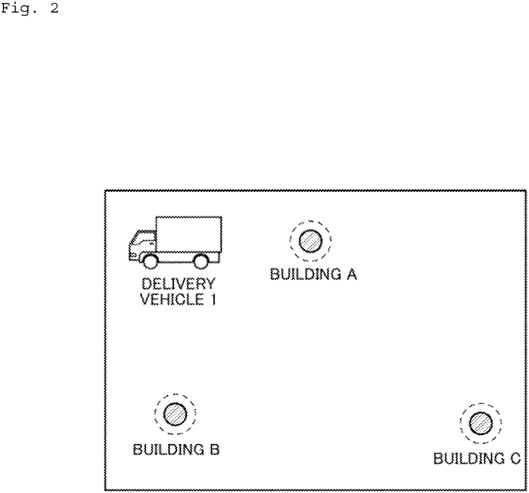

FIG. 2 is a diagram for explaining environment information held in the environment information database 12a. For example, in order to deliver fuel to buildings A, B, and C that are destinations using a delivery vehicle 1, information about the respective destinations (destination information) and information about the delivery vehicle 1 (delivery vehicle information) are needed. In the embodiment, the destination information and the delivery vehicle information are generally referred to as environment information. This information is held in the environment information database 12a.

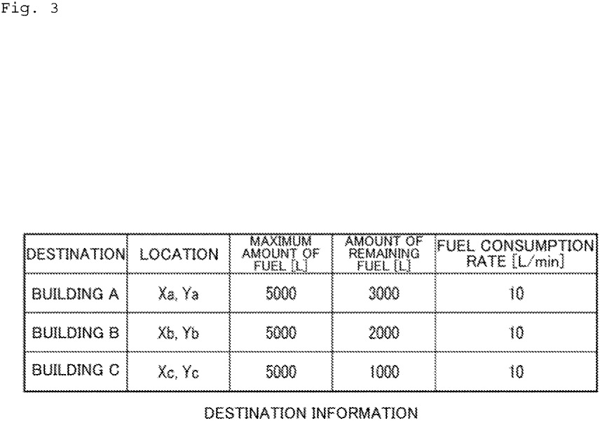

FIG. 3 is a diagram showing an example of destination information. The destination information can be shown in a table having multiple records including, for example, identifiers of the destinations (for example, names (building A, building B, and building C)), locations, a maximum amount of fuel [L], an amount of remaining fuel [L], and a fuel consumption rate [L/min]. Here, the maximum amount of fuel (Max Fuel) represents the maximum amount of fuel that can be stored in the tank or the like at the destination. The amount of remaining fuel represents the amount of fuel remaining at a particular point of time. The fuel consumption rate represents the amount of fuel consumed per unit time.

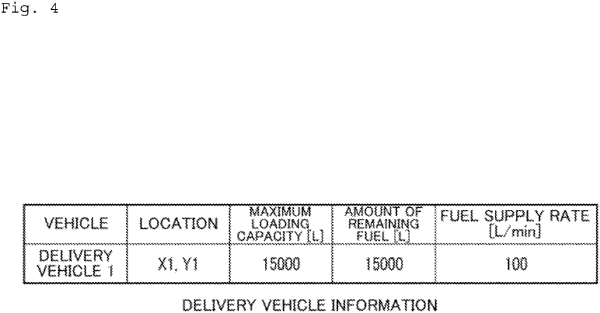

FIG. 4 is a diagram showing an example of delivery vehicle information. The delivery vehicle information can be shown in a table having multiple records including, for example, the identifier of a vehicle (e.g., the name (delivery vehicle 1)), location, maximum loading capacity [L], amount of remaining fuel [L], and fuel supply rate [L/min]. Here, the amount of remaining fuel is the total amount of fuel that can be supplied at a specific point of time. The fuel supply rate represents an amount of fuel to be supplied per unit time. Further, fuel (gasoline, diesel, or the like) for moving the delivery vehicle 1 itself will not be discussed. In other words, “fuel” in the specification means fuel for moving equipment (a private generator or the like) at a target value.

The memory 14 of FIG. 1 is, for example, a random access memory (RAM), and stores a trained model 14b and a delivery plan 14c in addition to a program 14a loaded from a storage. The trained model 14b is created by applying various conditions to a neural network with a specific structure and executing a simulation a plurality of times. The entity is a set of parameters including, for example, bias values of nodes and weights of edges included in a neural network.

The delivery plan 14c is information including an order of delivery of fuel to each of the destinations (the building A, building B, and building C) by the delivery vehicle 1 and the amount of fuel to be supplied to each destination (i.e., an unloading amount). The delivery plan 14c is created by inputting a specific condition to the trained model 14b. Learning of a neural network and creation of a delivery plan will be described in detail below.

Furthermore, the processor 11 shown in FIG. 1 is an arithmetic operation unit, for example, a central processing unit (CPU), a micro processing unit (MPU), or the like, and realizes its function using a program loaded in the memory 14.

The processor 11 includes an acquisition unit 111, an updating unit 112, a reward calculation unit 113, a learning unit 114, and a creation unit 115 as functional blocks (program modules) according to an embodiment. These functional blocks are processing functions realized by the processor 11 executing commands included in the program 14a. In other words, the delivery plan creation device 10 according to the present invention can be realized by a computer and a program. The program can be recorded and distributed on a recording medium such as an optical medium. Alternatively, the program can also be provided via a network.

The acquisition unit 111 accesses the environment information database 12a to acquire environment information, and creates an input condition as a premise of a delivery plan from the acquired environment information.

The creation unit 115 inputs the created input condition to a neural network reflecting the trained model 14b to create a delivery plan.

The reward calculation unit 113 calculates a reward value having a higher value of a delivery action that is an output of the neural network as the fuel depletion period at the destination becomes shorter. That is, an action to shorten a period of fuel depletion of the private generator installed at the destination has a higher value.

The learning unit 114 repeatedly executes simulations using a set having different environmental information and reward values. Then, the learning unit 114 creates a trained model by updating weighting parameters of the neural network based on the results of the respective executed simulations. The created trained model is stored in the memory 14 (trained model 14b).

The updating unit 112 updates the environment information of the environment information database 12a based on the results of the respective executed simulations.

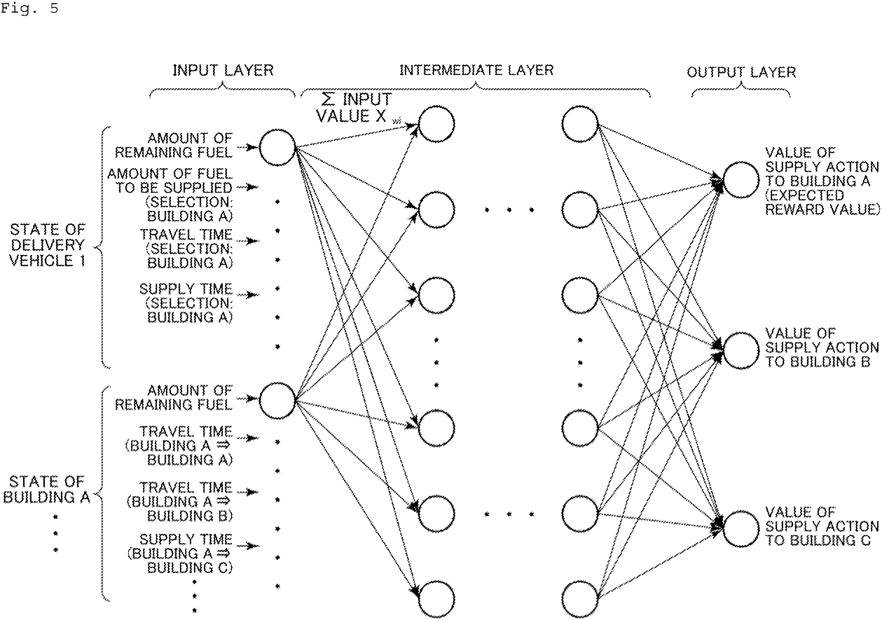

FIG. 5 is a diagram showing an example of the neural network according to an embodiment. The neural network shown in FIG. 5 is a so-called deep neural network (DNN) including at least one intermediate layer in addition to an input layer and an output layer. When an input condition from the acquisition unit 111 is input to the input layer, the neural network outputs a value of an action to supply fuel for each of destinations from the output layer. As is known to those skilled in the art, each node indicated by a circle has a bias value, and a line connecting nodes (an edge) has a weighting parameter wi. By repeating a simulation in which a certain input and a reward value for the input have been set, the bias value and the value of the weighting parameter adaptively change. This is called learning.

In an embodiment, a simulation using a set of different input conditions created based on the environment information database 12a and reward values for the input conditions is repeated. Then, by updating weighting parameters of the neural network based on the results of the simulation, the trained model 14b is created.

In FIG. 5, the input conditions given to the input layer include, for example, a state of the delivery vehicle 1, and a state of each destination (building A, building B, and building C). The state of the delivery vehicle includes, for example, an amount of remaining fuel that can be supplied, an amount of fuel to be supplied to each destination, a travel time, and a supply time (a time required for supply). A state of a building includes, for example, a time required for the delivery vehicle 1 to move to another building (travel time). The output layer outputs a value of an action (an expected value of reward) to supply fuel to each destination (building A, building B, and building C). Next, effects of the above configuration will be described.

### Effects

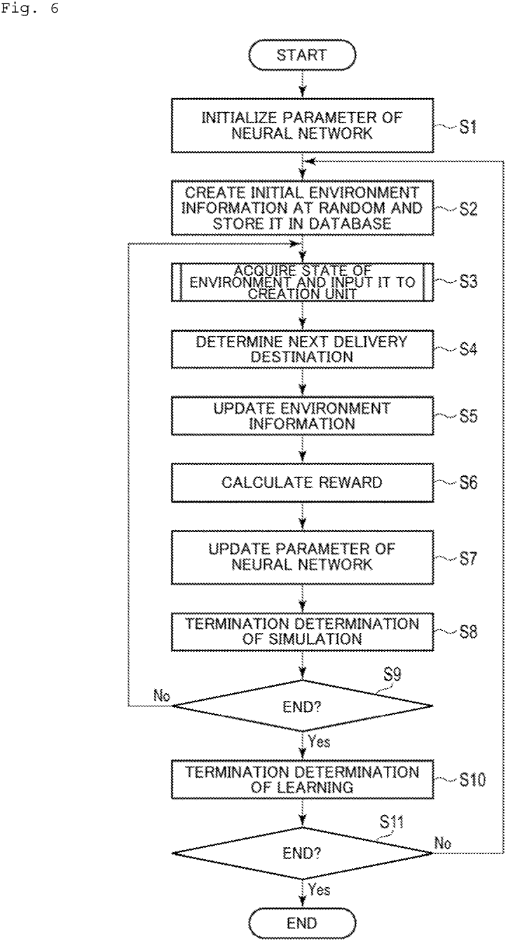

FIG. 6 is a flowchart showing an example of a processing procedure for learning of the neural network. This processing procedure is executed in a training mode in which a simulation is repeated. Further, an existing learning algorithm, for example, DQN, Actor-Critic, or the like can be utilized for learning.

In FIG. 6, the processor 11 first initializes parameters of the neural network (step S1). Then, the processor 11 creates initial environment information at random and stores it in the environment information database 12a (step S2).

Next, the processor 11 acquires the environment information from the environment information database 12a, and creates an input condition (a state of the environment) for computing a delivery plan (step S3). The obtained input condition is input to the neural network of the creation unit 115. Here, the creation of the input condition will be described.

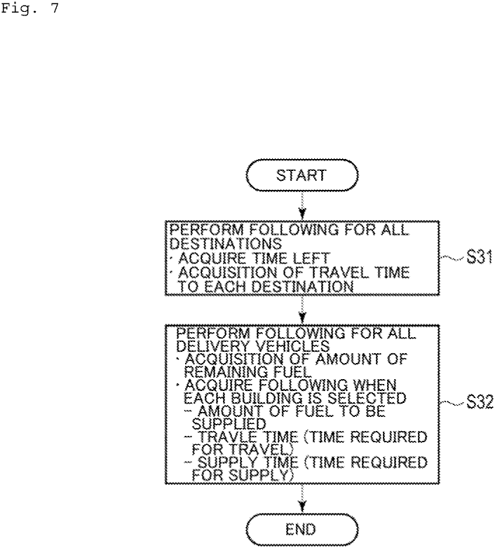

FIG. 7 is a flowchart showing an example of a processing procedure of step S3 of FIG. 6. In step S3, the processor 11 (the acquisition unit 111) acquires information of the fuel and time from the environment information. All information is an important factor for creating a delivery plan. In FIG. 6, the processor 11 acquires the times left with respect to all destinations and the travel time to each of the destinations (step S31). Here, the time left can be calculated using, for example, equation (1).

$$\begin{matrix}\text{Time} \text{Left} \text{=} \text{the amount of remaining fuel/the fuel consumption} \\ \text{rate} \left(\text{in the case of the current amount of remaining fuel} \underline{\geq } 0\right) \\ = \text{the time that has elapsed since fuel was depleted (in the} \\ \text{case of the current amount of remaining fuel < 0)}\end{matrix} \qquad \text{(1)}$$

The travel time for each destination can be acquired by inputting location information of each destination to the traffic situation providing system 2, for example. That is, when a request including the location information of a destination is sent to the traffic situation providing system 2, a reply including the travel time is returned.

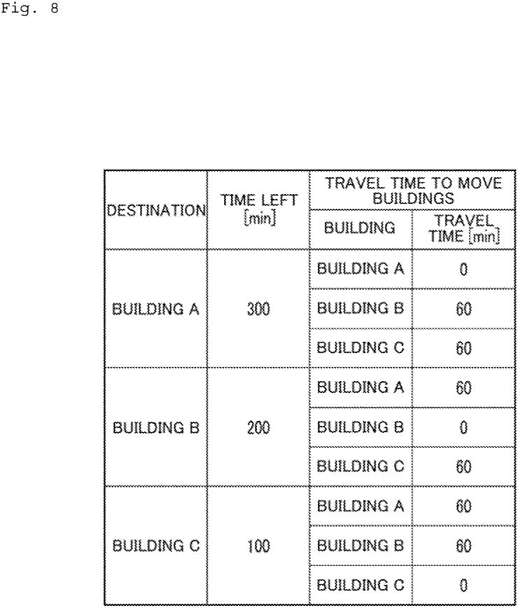

FIG. 8 is a diagram showing an example of information created in step S31 of FIG. 7. As shown in FIG. 8, the time left and the travel time between buildings are obtained for each destination. This information is utilized as input conditions to the neural network.

Next, the processor 11 acquires, for all delivery vehicles, the amount of remaining fuel, the amount of fuel to be supplied when each building is selected, the travel time (the time required for travel), and the supply time (the time required to supply the fuel) (step S32).

Here, the amount of fuel to be supplied can be calculated using, for example, equation (2).

$$\begin{matrix}\text{The amount of fuel to be supplied = the amount of target} \\ \text{supply - the amount of remaining fuel at the destination} \\ \text{The amount of target supply = the maximum amount of fuel of} \\ \text{the destination x coefficient k} \left(0 < \text{k} \underline{\leq } 1.0\right)\end{matrix} \qquad \text{(2)}$$

The travel time can be calculated based on the travel time between the destinations obtained in step S31, the present location of the delivery vehicle, the traffic situation or the like at a specific point of time acquired by accessing the traffic situation providing system 2. The supply time can be calculated using, for example, equation (3).

$$\begin{matrix}\text{The supply time} \text{=} \text{the amount of fuel to be supplied/the fuel} \\ \text{supply rate of the delivery vehicle}\end{matrix} \qquad \text{(3)}$$

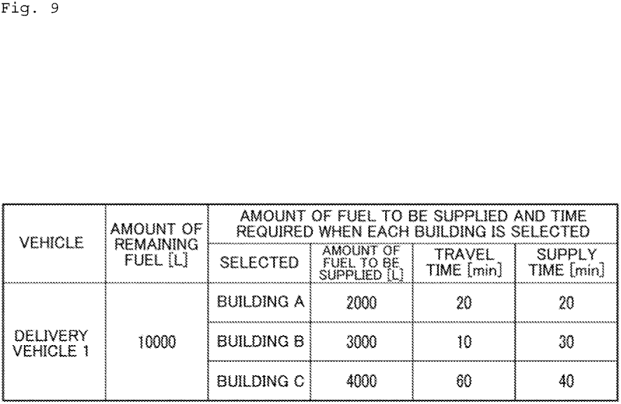

FIG. 9 is a diagram showing an example of the information created in step S32 of FIG. 7. As shown in FIG. 9, the amount of remaining fuel, the amount of fuel to be unloaded when each destination is selected, and the required time (travel time and supply time) are required for the delivery vehicle. This information is utilized as input conditions to the neural network.

Returning to FIG. 6, description will now be continued. In a step S4 of FIG. 6, the processor 11 determines the next delivery destination (step S4), and then updates the environment information of the environment information database 12a (step S5). Furthermore, the processor 11 calculates the reward value for updating the parameters of the neural network (step S6), and updates the parameters of the neural network based on the result (step S7).

Furthermore, the processor 11 determines whether a termination condition for the simulation is satisfied (step S8), and repeats the procedure from step S3 until the termination determination becomes Yes (step S9). In step S9, for example, when an elapsed time t from the start of the simulation passes a predetermined time tend, the termination determination is Yes. Alternatively, when the delivery simulation for all of the destinations is completed, the termination determination is Yes.

Furthermore, the processor 11 determines whether a termination condition for the learning mode is satisfied (step S10), and repeats the procedure from step S2 until the termination determination becomes Yes (step S11). In step S11, for example, when a predetermined number of simulations are executed, the termination determination is Yes.

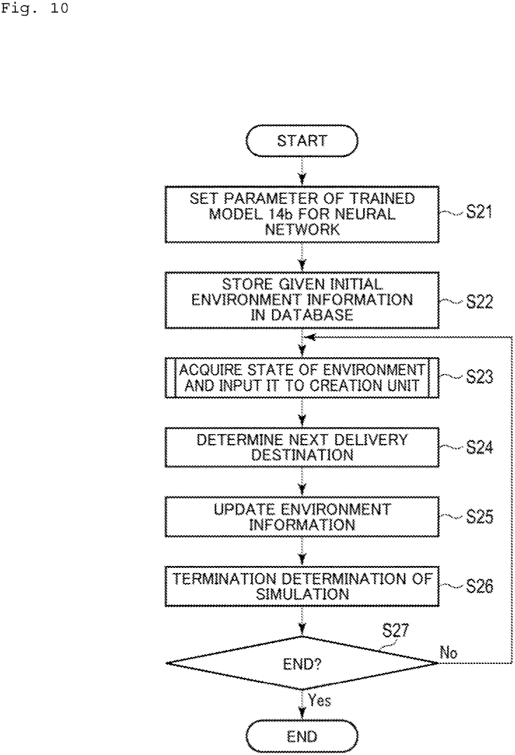

FIG. 10 is a flowchart showing an example of a processing procedure for creation of a delivery plan. This processing procedure is executed in an output mode. In an embodiment, a delivery plan is output through a fuel delivery simulation using the neural network to which the trained model has been applied.

In FIG. 10, the processor 11 sets a parameter of the trained model 14b for the neural network (step S21). Next, the processor 11 stores given initial environment information in the environment information database 12a (step S22). Next, the processor 11 acquires the state of the environment through the same procedure as the flowchart of FIG. 7, and inputs the state to the neural network of the creation unit 115 (step S23) .

Next, the processor 11 determines the next delivery destination (step S24), and then updates the environment information of the environment information database 12a (step S25). Furthermore, the processor 11 determines whether a termination condition for the simulation is satisfied (step S26), and repeats the procedure from step S23 until the termination determination becomes Yes (step S27). In step S27, for example, when an elapsed time t from the start of the simulation passes a predetermined time tend, the termination determination is Yes. Alternatively, when the delivery simulation for all of destinations is completed, the termination determination is Yes.

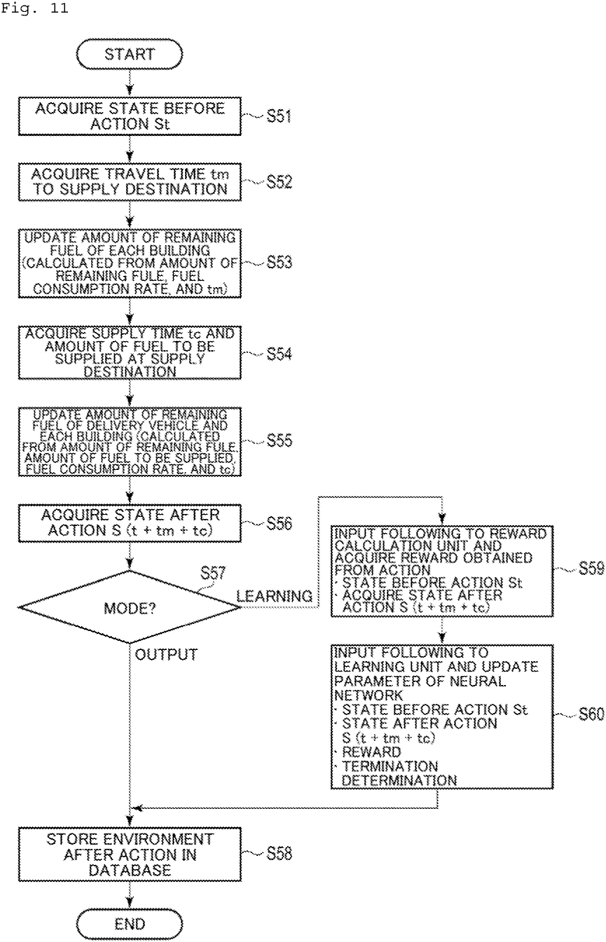

FIG. 11 is a flowchart showing an example of the processing procedure for the updating unit 112 of the processor 11. The updating unit 112 simulates a change that may be made in the environment information when fuel is delivered to the delivery destination selected by the creation unit 115, and stores the result in the environment information database 12a.

In FIG. 11, the processor 11 acquires an initial state, that is, a state St before a delivery action (step S51). Next, the processor 11 acquires a travel time tm with respect to a supply destination (step S52). Next, the processor 11 updates the amount of remaining fuel of each of the destination (the building A, building B, and building C) (step S53). The amount of remaining fuel can be calculated from the amount of remaining fuel at that moment, the fuel consumption rate, and the travel time tm.

Next, the processor 11 acquires a supply time tc and the amount of fuel to be supplied at the supply destination (step S54), and updates the amount of remaining fuel (supply possible amount) of the delivery vehicle and the amount of remaining fuel of each building (step S55). The amount of remaining fuel of the delivery vehicle can be calculated from the amount of remaining fuel at that moment, the amount of fuel to be supplied to the delivery destination, the fuel consumption rate, and tc.

Further, the processor 11 acquires the state S after the action (t + tm + tc) (step S56), and then determines a mode of the simulation (step S57). In the output mode, the processor 11 stores the environment after the action in the environment information database 12a (step S58).

On the other hand, if the learning mode is set in the step S57, the processor 11 inputs the state before the action St, the state after the action S (t + tm + tc) to the reward calculation unit 113 to calculate a state a reward value obtained from the action (step S59). Here, the calculation of the reward value will be described.

### Calculation of Reward Value

The reward calculation unit 113 calculates a reward value for updating the weighting parameter of the neural network of the creation unit 115. The reward value can be calculated as, for example, the sum of a positive reward (rewarding) obtained by delivering fuel and a negative reward (penalty) brought by fuel depletion. Further, either of a reward and a penalty may be calculated.

A positive reward can be calculated, for example, by inputting the time left at the moment with respect to the maximum time left until the fuel is depleted into a predetermined reward function. A penalty can be calculated by inputting the number of destinations in which the fuel has been depleted and the time that has elapsed since the fuel was used up to a predetermined reward function.

The reward is calculated according to the policy that, for example, a higher reward will be given when the time left at the moment (the current amount of fuel/the fuel consumption rate) with respect to the maximum time left until the amount of fuel becomes zero (the maximum amount of fuel/the fuel consumption rate) has been calculated and fuel has been supplied to the destination with a lower calculated value. Alternatively, a higher reward may be given when fuel has been supplied to a destination where the current amount of remaining fuel with respect to the maximum amount of fuel is smaller.

That is, the reward calculation unit 113 calculates a reward value based on at least any of the time left at the moment with respect to the maximum time left until the fuel is depleted, the current amount of remaining fuel with respect to the maximum amount of fuel, the number of destinations where fuel has been depleted, and the time that has elapsed since fuel was depleted.

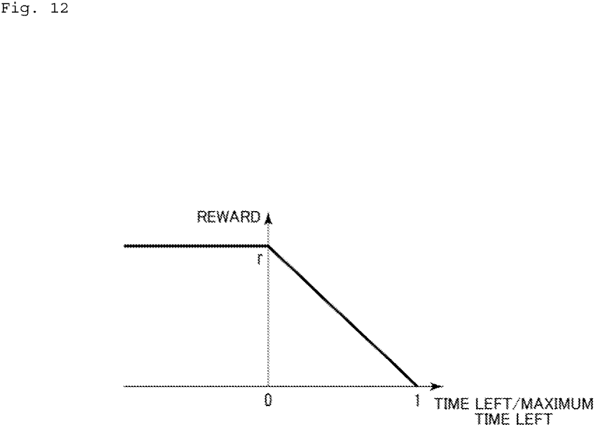

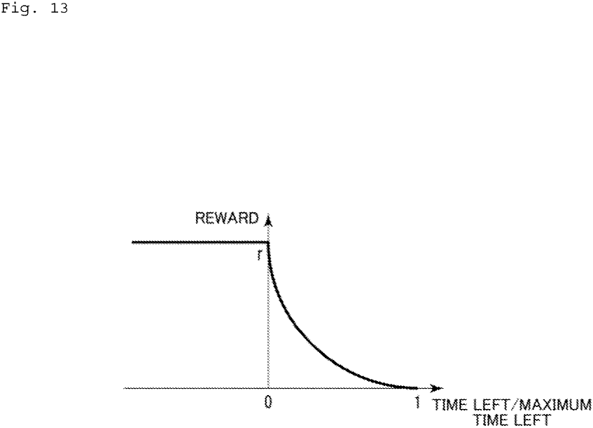

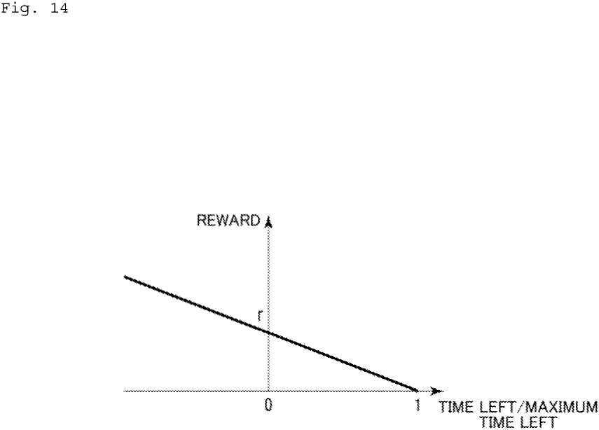

FIG. 12 is a diagram showing an example of the reward function. In the graph of FIG. 12, the horizontal axis represents [a time left/a maximum time left], the vertical axis represents reward, and the intercept value r when the horizontal axis has the value of zero is set to an arbitrary value. For example, a reward function which monotonously decreases from r can be used to calculate a reward value. Alternatively, a reward function which decreases non-linearly from r can be used as shown in FIG. 13. Alternatively, a reward function which decreases linearly from the negative region of the horizontal axis can be used as shown in FIG. 14.

A negative reward (penalty) can be calculated according to a policy that a heavier penalty will be given when, for example, the number of destinations in which the time left until fuel runs out is zero or shorter, or when the time is long. For example, equation (4) can be applied.

$$\begin{matrix}\text{Penalty} \text{=} \text{-} \text{(the number of destinations in which the time left} \\ \text{until fuel runs out is zero or shorter/the number of all} \\ \text{destinations)}\end{matrix} \qquad \text{(4)}$$

Alternatively, equation (5), may be applied.

$$\begin{matrix}\text{Penalty = - (the sum of time that has elapsed since the} \\ \text{amounts of fuel of the destinations became zero)}\end{matrix} \qquad \text{(5)}$$

Alternatively, equation (6), may be applied.

$$\begin{matrix}\text{Penalty = - (the sum of times elapsed since the amounts of} \\ \text{fuel of the destinations became zero until delivery of this} \\ \text{time is completed)}\end{matrix} \qquad \text{(6)}$$

A reward value can be obtained from, for example, equation (7) by combining a reward and a penalty.

$$\begin{matrix}\text{Reward value = reward} \times \text{a + penalty} \times \text{b (wherein, a and b} ∈ \\ \text{any number)}\end{matrix} \qquad \text{(7)}$$

Description will now return to FIG. 11. In step S60 of FIG. 11, the processor 11 inputs the state before the action St, the state after the action S (t + tm + tc), the reward value, and the result of a termination determination to the learning unit 114 to update the parameter of the neural network (step S60) .

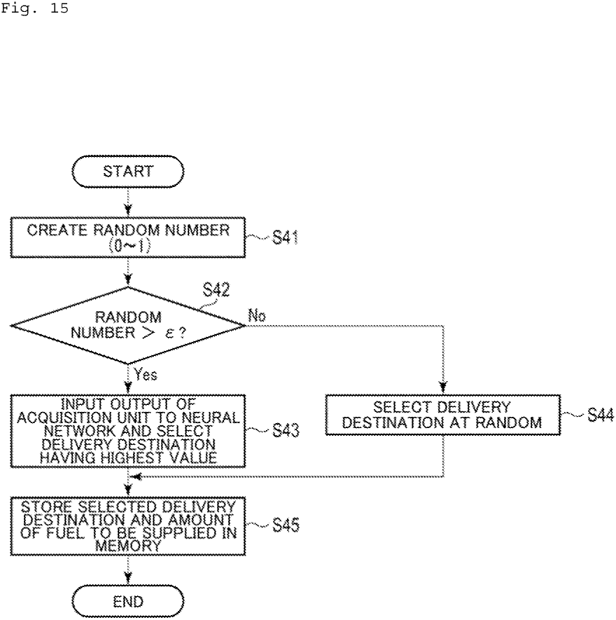

FIG. 15 is a flowchart showing an example of a processing procedure for creation of a delivery plan. In FIG. 15, the processor 11 first creates a random number from 0 to 1 (step S41). If the random number is smaller than a predetermined value ε (No in step S42), and the processor 11 randomly selects a delivery destination (step S44). Here, ε represents the probability that the delivery vehicle takes a random action, and 0 ≦ ε ≦ 1 is satisfied. The processor 11 stores the selected delivery destination and the amount of fuel to be supplied in a delivery plan 14c of the memory 14 (step S45).

On the other hand, if the random number is greater than ε in step S42 (Yes), the processor 11 inputs an input condition created by the acquisition unit 111 to the neural network and selects the delivery destination having the highest value (step S).

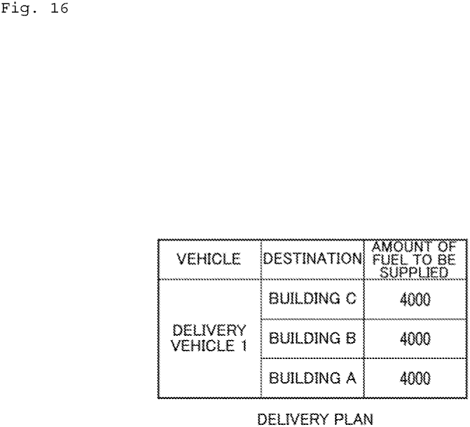

FIG. 16 is a diagram showing an example of the delivery plan. According to an embodiment, a delivery plan in which the delivery vehicle 1 is designed to go around the destinations in the order of the building C, the building B, and the building A, and the amount of fuel to be supplied at each destination is set to 4000L is obtained.

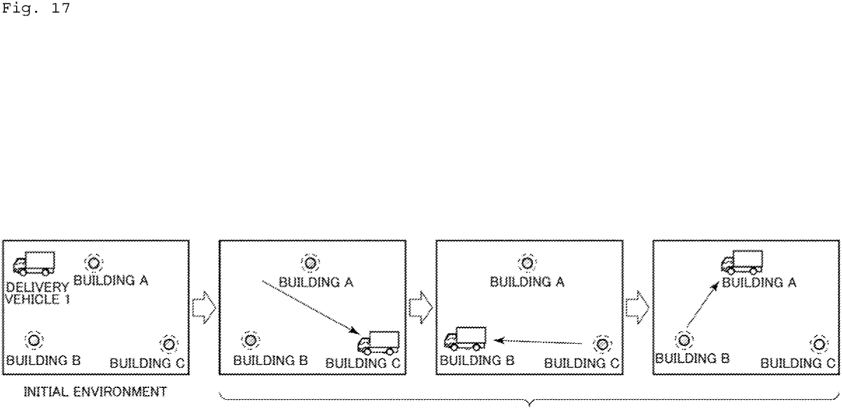

FIG. 17 is a diagram showing an example of an action based on the delivery plan of FIG. 16. The action of moving from the initial environment to the building C first and then to the building B, and the building A is most efficient as shown in FIG. 17.

### Effect

In the embodiment, a highly effective delivery plan to prevent fuel depletion can be calculated by utilizing the neural network as described above. That is, a plurality of input conditions are created from environment information registered in a database in advance, and a trained model is created by repeating a simulation using a neural network. Then, information acquired from the traffic situation providing system is also input to the trained model to automatically search for the delivery route and create the delivery plan. Furthermore, the result of an action can be evaluated numerically. That is, by reflecting positive evaluation of delivery to a destination at which the time left until fuel depletion is shorter and negative evaluation of delivery made after fuel depletion on learning, accuracy in route search and creation of a delivery plan can be automatically improved.

In the related art, when power supply to a communication building is interrupted due to the occurrence of a disaster, it is necessary to manually create a delivery plan considering the location, the fuel state, the traffic state, and the like of each building, and it takes time and skill for the examination of the delivery plan.

According to an embodiment with respect to this problem, it is possible to obtain an optimum solution (an optimum route) in an approach using a neural network based on learning of various input information and cases in consideration of environment conditions during a disaster such as a fuel state. That is, according to the embodiment, it is possible to compute a highly effective delivery plan to prevent fuel depletion by utilizing the neural network.

Thus, according to the embodiment, it is possible to efficiently create a delivery plan capable of shortening a fuel depletion period. As a result, the delivery plan for shortening the time for which the fuel at the destination has been depleted can be automatically determined in a short time, and the skillless of creation of the delivery plan and time reduction can be realized.

Further, the present invention is not limited to the above-described embodiment. For example, the reward function is not limited to the one described with reference to the drawings. In other words, the present invention is not limited to the above-described embodiment as is, and in the implementation stage, various modifications of the constituent components are possible without departing from the spirit of the invention. Also, various inventions can be formed by suitably combining a plurality of constituent components disclosed in the above-described embodiment. For example, some constituent elements may be omitted from all of the constituent elements in the embodiments. Furthermore, constituent elements of different embodiments may be combined as appropriate.

### REFERENCE SIGNS LIST

1 Delivery vehicle
2 Traffic situation providing system
3 Delivery plan
10 Delivery plan creation device
11 Processor
12 Storage
12a Environment information database
13 Interface unit
14 Memory
14a Program
14b Trained model
14c Delivery plan
100 Network
111 Acquisition unit
112 Updating unit
113 Reward calculation unit
114 Learning unit
115 Creation unit

1. A delivery plan creation device configured to create a delivery plan including an order of delivery of fuel to a destination using a delivery vehicle and an amount of the fuel to be supplied, the delivery plan creation device comprising:
a database configured to store environment information including destination information related to the destination and delivery vehicle information related to the delivery vehicle;
a storage unit configured to store a trained model created by training a neural network having at least an input layer and an output layer in advance based on the different environment information; and
a processor, wherein
the processor includes
an acquisition unit configured to access the database to acquire the environment information and create an input condition that is a premise of the delivery plan from the environment information, and
a creation unit configured to create the delivery plan by inputting the input condition to the neural network reflecting the trained model.

2. The delivery plan creation device according to claim 1, wherein when the input condition is input to the input layer, the neural network outputs a value of an action for supplying the fuel to each of the destinations from the output layer,
the processor further includes
a reward calculation unit configured to calculate a reward value having a higher value of the action as the fuel depletion period at the destination becomes shorter,
a learning unit configured to repeat a simulation using different sets of the environment information and the reward value, and to update a weighting parameter of the neural network based on a result of the simulation to create the trained model, and
an updating unit configured to update the environment information based on the result of the simulation.

3. The delivery plan creation device according to claim 2, wherein the reward calculation unit calculates the reward value based on at least any of a current time left with respect to the maximum time left until the fuel is depleted, the current amount of remaining fuel with respect to the maximum amount of fuel, the number of destinations where the fuel has been depleted, and the time that has elapsed since the fuel was depleted.

4. The delivery plan creation device according to claim 1 3, wherein the acquisition unit accesses a traffic situation providing system to acquire a traffic situation at a specific time point, and creates the input condition including the traffic situation.

5. The delivery plan creation device according to claim 1, wherein the destination information includes at least an identifier, a location, a maximum amount of fuel, an amount of remaining fuel, and a fuel consumption rate of the destination.

6. The delivery plan creation device according to claim 1, wherein the delivery vehicle information includes at least an identifier, a location, a maximum loading capacity, an amount of remaining fuel, and a fuel supply rate of the delivery vehicle.

7. A delivery plan creation method for creating a delivery plan including an order of delivery of fuel to a destination using a delivery vehicle and a supply amount of the fuel using a computer capable of accessing a database holding environment information including destination information about the destination and vehicle information about the delivery vehicle, the delivery plan creation method comprising:
a step of, by the computer, accessing the database to acquire the environment information and create an input condition that is a premise of the delivery plan from the environment information, and
a step of, by the computer, inputting a trained model created by training a neural network having at least an input layer and an output layer in advance based on the different environment information to the neural network to create the delivery plan.

8. A program including a command for causing the computer to execute each of the steps included in the delivery plan creation method according to claim 7.
